(19) United States
(12) Patent Application Publication
(10) Pub. No.: US 2006/0152430 A1
(43) Pub. Date: Jul. 13, 2006

(54) Periodic electromagnetic structure

(76) Inventors: Nigel Seddon, Bristol (GB); Sajad Haq, Bristol (GB)

Correspondence Address: CROWELL & MORING LLP;INTELLECTUAL PROPERTY GROUP, P.O. BOX 14300, WASHINGTON, DC, 20044-4300, US

(21) Appl. No.: 10/527,748

(22) PCT Filed: Sep. 3, 2003
(86) PCT No.: PCT/GB03/03808

§ 371 Date: Nov. 7, 2005

(30) Foreign Application Priority Data
Sep. 14, 2002 (GB) 0221421.1

(51) Int. Cl. H01Q 15/02

(52) U.S. Cl. 343/909; 343/700 MS

(57) ABSTRACT

This invention relates to periodic electromagnetic structures (20) for use over a relatively large range of frequencies. In particular, this invention relates to microwave applications, such as antennas and low reflectivity structures. A periodic electromagnetic structure (20) is provided that comprises an array of conducting LC elements (22;22a,22b;42;52;68) in superposition with a frequency-dependent dielectric (30;44;54;70) whose permittivity and/or permeability varies according to the frequency of radiation incident thereon such that the resonant frequency of the LC elements (22;22a,22b;42;52;68) follows the frequency of the incident radiation.

This invention relates to periodic electromagnetic structures for use over a relatively large range of frequencies. In particular, this invention relates to microwave applications, such as antennas and low reflectivity structures.

Periodic electromagnetic structures are particularly useful as they can be used selectively to allow propagation, absorption or reflection of electro-magnetic radiation. Periodic electromagnetic structures may be metallic or dielectric (or a combination of both) and comprise periodic spatial variations in their structure on a scale that is much smaller than the electromagnetic wavelength. These structures produce pass bands and stop bands for propagation of electromagnetic waves through or across the structure.

Many periodic electromagnetic structures rely on the use of electrically resonant elements to provide the required behaviour. These periodic structures are designed so that an incident electromagnetic signal, or an applied AC signal, excites resonant electrical and magnetic fields in the structure. The resonant electrical and magnetic fields that can be induced in such a structure may be significantly different from the fields that would be induced in a simple conducting sheet. Consequently, the interaction of radiation with these structures may be fundamentally different from that observed with simple electrically-conductive or magnetic-based structures. This property is exploited in each of the four example applications detailed below.

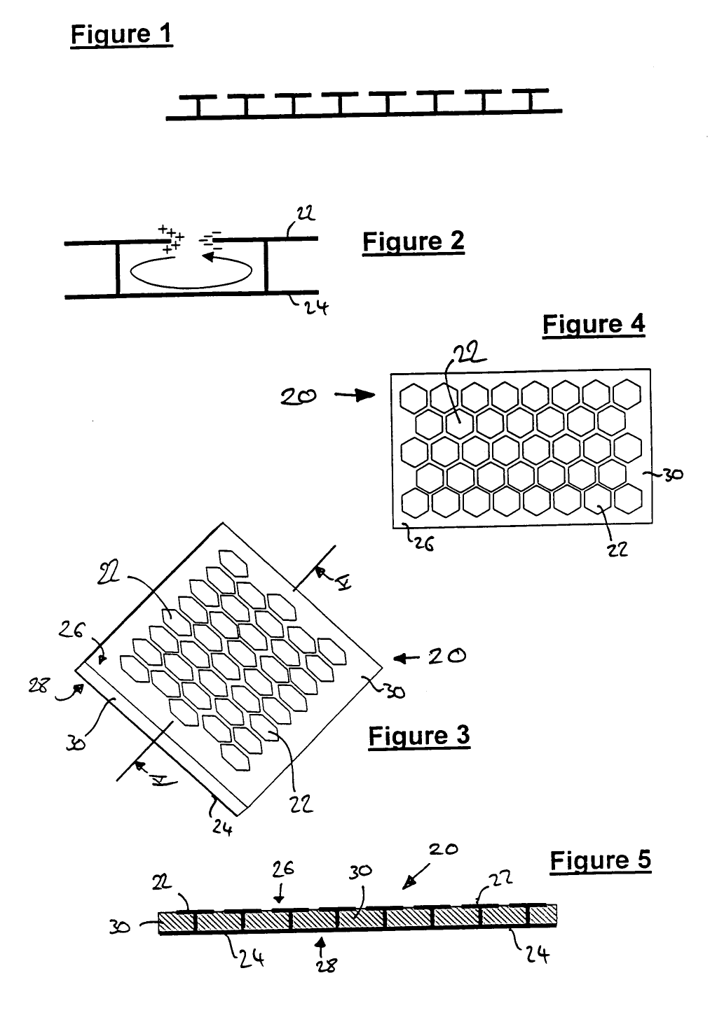

‘High-impedance Electromagnetic Surfaces with a Forbidden Frequency Band’ by Sievenpiper et al, published in the IEEE Transactions on Microwave Theory and Techniques 1999 volume 47 pages 2059 to 2074, discloses a high-impedance surface that comprises a flat conducting plate and resonant elements in the form of a two-dimensional array of thumbtack-like protrusions that extend from the plate. This arrangement corresponds to that illustrated in FIGS. 1 and 4 herein.

Each of the thumbtacks can be treated as an LC circuit element: capacitance is derived from charges building up on the edges of adjacent thumbtacks and inductance is derived from current flow around a circular path between the charge accumulations. Both of these effects are shown schematically in FIG. 2.

The overall effect of the thumbtacks is that the structure conducts DC, but does not conduct AC within a forbidden frequency band that is determined by the geometry of the structure. This means that the surface does not support surface waves (surface currents for the case of incident microwave radiation) and that image currents are in-phase.

This last effect is significant when considered against standard ground planes. Standard ground planes, such as flat conducting plates, are often put behind microwave transmitting antennas as a way of increasing signal strength through reflection. However, standard ground planes have image currents that are out-of-phase and so tend to cancel the incoming signal unless located a quarter of a wavelength from the antenna. This is not always practicable where space is at a premium, e.g. in mobile phone handsets.

A high-impedance surface, such as that disclosed by Sievenpiper is useful because the in-phase image currents mean that it can be located directly behind the transmitter antenna. Moreover, the fact that it is a high-impedance surface means that it does not support surface currents and so is a very efficient reflector.

A variation on the high-impedance surface arrangement shown in Sievenpiper is disclosed in ‘Aperture-Coupled Patch Antenna on UC-PBG Substrate’ by Coccioli et al, published in the IEEE Transactions on Microwave Theory and Techniques 1999 volume 47 pages 2123 to 2130. UC-PBG stands for ultra compact photonic bandgap. These structures operate on similar principles to the high-impedance surface described above, but the UC-PBG structure is relatively easy to manufacture. The UC-PBG structure consists of a two dimensional array of LC elements, created by patterning a thin conductive sheet onto a grounded dielectric substrate. An example of a pattern is illustrated in FIG. 9. The pattern is designed to produce local inductive and capacitive regions that behave as parallel resonant LC elements. UC-PBGs are suitable for use as ground planes for microwave circuits or backing planes for antennas—Coccioli refers to application in a microwave patch antenna.

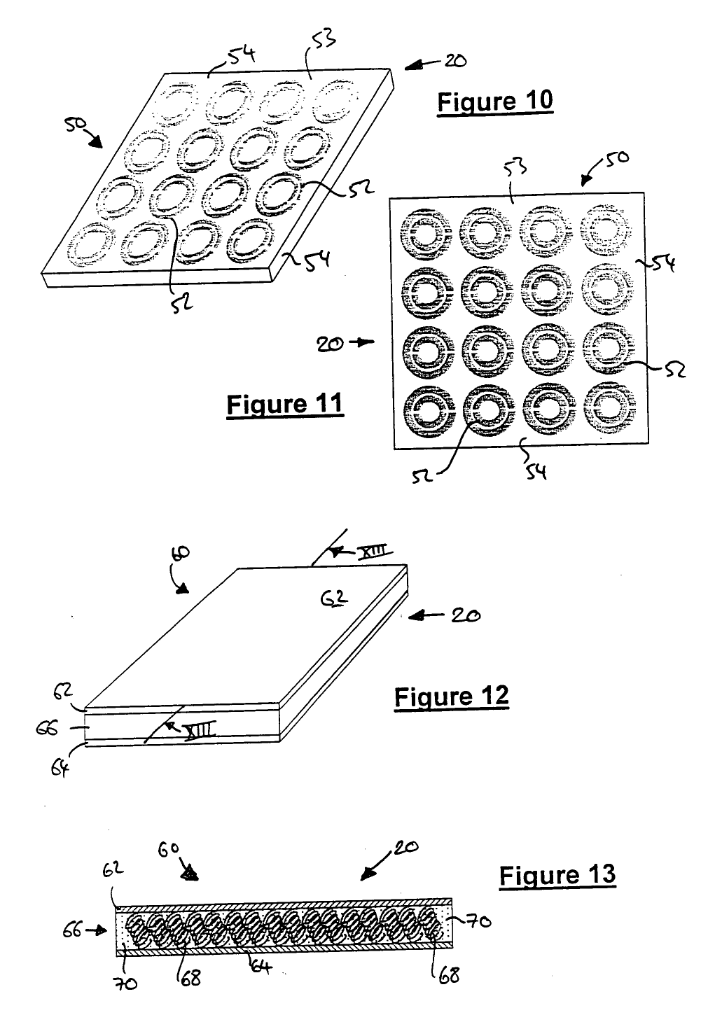

A third example of the use of periodic electromagnetic structures that rely on resonance phenomena are ‘negative refractive index’ materials. An example of such a material is disclosed in ‘Composite Medium with Simultaneously Negative Permeability and Permittivity’ by Smith et al, published in Physical Review Letters 2000 volume 84 pages 4184 to 4187. In this case, a periodic array of split-ring resonators, such as that shown in FIGS. 10 and 11, is used to produce a material with negative effective magnetic permeability. The split ring resonators are small, electrically-conductive structures that are designed to have suitable self inductance and internal capacitance, i.e. to be LC elements.

A fourth example of periodic electromagnetic structures that rely on resonant phenomena are chiral materials, i.e. those that possess handedness such that they may exist in either a left-handed or right-handed form. An example of such a structure is given in our patent application EP-A-0,758,803. Such chiral materials display interesting microwave properties and may find application for low reflectivity surfaces, waveguides, antennas, polarisers and phase shifters. A common chiral element that may be employed for microwave applications is a helix: the dimensions of the helix control the microwave activity of the helix-loaded structure. Typically a structure would be fabricated by embedding helices in a matrix, as shown in FIG. 13. Other examples of chiral elements are spiral coils, conical coils and ‘plano-chiral’ structures. Although plano-chiral structures are not truly chiral because they do not possess a non-superimposable geometry, they act a chiral elements if movement is restricted to two dimensions. Plano-chiral elements are useful due to their ease of fabrication as they may consist of patterned thin film structures (e.g. spirals or swastikas). The microwave activity of all of these chiral structures display resonant characteristics that can be modelled on the basis of treating the chiral elements as parallel resonant LC elements.

However, all of the above structures suffer the disadvantage that they only work well for incident radiation having a frequency coincident with the resonant frequency of the LC elements they contain. In the case of high-impedance surfaces, high reflectivity and in-phase image currents only occur over a narrow resonant frequency range. For split-ring resonators, the structure only displays the desirable combination of negative permeability and negative permittivity over a narrow range of resonant frequencies. For chiral structures, they impart the microwave properties only over their narrow range of resonant frequencies. In each case, the resonant frequency is determined by the well known equation

$${ω}_{0} = \frac{1}{\sqrt{LC}}$$

where the inductance (L) and capacitance (C) of the LC elements are, in turn, determined by the geometry of the structure. Accordingly, the structures are of limited use due to their narrow operating bandwidth, typically a few tens of percent.

One technique that has been implemented to increase their operating bandwidth is to include non-linear voltage-dependent components in the structure, such as varactor diodes. The use of varactor diodes allows the operating frequency of a high-impedance surface to be changed by changing the bias voltage across the varactor diode. This allows the resonant frequency of the LC elements to be changed by a factor of two. However a significant problem with the use of varactor diodes is that the two dimensional array of LC elements require a complex network of conductors to supply the bias voltage to each diode.

Hence, there remains a general need for periodic electromagnetic structures that display their advantageous properties over a wider range of frequencies. For example, one requirement is for multifunction antennas that will allow a wide range of frequencies to be transmitted by a single antenna structure, thereby reducing the number of separate antennas that are required on a single platform.

The present invention resides in a periodic electromagnetic structure comprising an array of conducting LC elements in superposition with a frequency-dependent dielectric whose permittivity and/or permeability varies according to the frequency of radiation incident thereon such that the resonant frequency of the LC elements follows the frequency of the incident radiation.

By ‘dielectric’, we mean to include materials that display a permeability variation only, in addition to materials that display a permittivity variation only, and also to include materials that display both permeability and permittivity variation. Changes in the permittivity and/or permeability of the dielectric will cause the capacitance and/or inductance of the LC elements to change. This, in turn, causes a change in the resonance frequency of the structure. Hence, the resonant frequency of the LC elements can be adjusted by changing the properties of the dielectric. Careful selection of the dielectric leads to a change in permittivity and/or permeability that causes the resonant frequency of the LC elements to follow the frequency of the incident radiation.

The use of a frequency-dependent dielectric enables the periodic electromagnetic structures to exhibit resonant behaviour over a far wider range of frequencies than the existing art. Matching the incident radiation frequency to that of the structural resonance can be achieved over typically a factor of ten. Accordingly, the present invention can be used in high-impedance surfaces, UC-PBGs, split-ring resonators or chiral materials to increase greatly their useful bandwidth.

A notable feature of the present invention is that the periodic electromagnetic structure responds only resonantly at the frequency at which it is excited by the incident radiation. This can be contrasted with other prior art structures that are designed to be responsive across a wide range of frequencies. Generally structures that are required to be responsive over a large range of frequencies are required to have low values of Q (quality factor) in order to provide a large bandwidth. For antenna structures and microwave circuit components, this can translate into low sensitivity in the case of sensors, or low gain in the case of transmitters and oscillators. The present invention allows the periodic electromagnetic structures to be used over a wide range of frequencies. However, the structures display relatively strong resonant characteristics at any incident radiation frequency. This leads to an enhanced Q factor.

Preferably, a dielectric with suitable frequency dependent characteristic is incorporated into the structure such that the resonant frequency of the structure automatically adjusts to be substantially equal to the frequency of the incident radiation.

Optionally, the frequency-dependent dielectric has a response to incident radiation such that the product of the permittivity and permeability of the dielectric varies in proportion to the reciprocal of the square of the frequency of the incident radiation. This is advantageous because the resonant frequency ω varies as

$$ω ∝ \frac{1}{\sqrt{LC}}$$

where L is the inductance and C the capacitance. Accordingly, the capacitance can vary leaving the inductance constant or the inductance can vary leaving the capacitance constant or both the inductance and capacitance can vary. Where both inductance and capacitance vary, their relative rates of change can vary although it is preferred that their product remains in proportion to the reciprocal of the square of the frequency of the incident radiation.

Optionally, the LC elements are protrusions from a flat conducting plate. This arrangement is convenient as it lends itself to both inductive and capacitive coupling between elements. Conveniently, the frequency-dependent dielectric may abut the conducting plate and the protrusions may extend at least partially into the dielectric. This arrangement ensures that the resonant frequency of the LC elements is changed as they are surrounded by dielectric. In a currently preferred embodiment, the protrusions are generally thumbtack shaped.

The periodic electromagnetic structure may, optionally, form an ultra compact photonic bandgap device or a split ring resonator. In either of these devices, it is convenient for the LC elements to be disposed across the surface of the frequency-dependent dielectric. For example, the LC elements may be printed onto the dielectric or may be formed by metal deposition through a suitable mask or the like to obtain a desired pattern.

The structure may comprise one or more of the group of chiral conductors, plano-chiral conductors, pseudo-chiral conductors or omega conductors. Optionally, the chiral structure may be helical. Conveniently, the chiral conductors may be set within the frequency dependent dielectric. The helical elements may be set in the dielectric in a common orientation, as described in our patent application EP-A-0,758,803.

Optionally, the structure forms a high-impedance surface. It is often advantageous to maximise the impedance of the surface through careful selection of the geometry of the LC elements and properties of the dielectric employed, thereby to ensure maximum reflection from the surface and optimum performance when used as a reflector behind an antenna transmitter. However, in an alternative application it is preferable to make the surface impedance of the periodic electromagnetic structure substantially 377Ω, thereby to match the impedance of free space. The structure can then be used for example as an integral part of a radar absorbent material where the absorption is effected through dissipative mechanism in the absorber.

Optionally, the frequency-dependent dielectric is Philips ferrite material type 4E1.

The invention also resides in an antenna comprising a periodic electromagnetic structure as described herein above and in a mobile phone handset comprising such an antenna. The invention also resides in a radar absorbent material comprising a periodic electromagnetic structure as described herein before, wherein the surface impedance of the structure is substantially 377Ω thereby to match the impedance of free space.

In order that the invention can be more readily understood, reference will now be made, by way of example only, to the accompanying drawings in which:

FIG. 1 is a cross-section of a periodic electromagnetic structure in the form of a high-impedance surface according to the prior art;

FIG. 2 is an illustration of the mechanisms that give capacitive and inductive coupling between the LC elements of FIG. 1;

FIG. 3 is a perspective view of a periodic electromagnetic structure according to a first embodiment of the invention;

FIG. 4 is a plan view of the periodic electromagnetic structure of FIG. 3;

FIG. 5 is a cross-section taken through line V-V of FIG. 3;

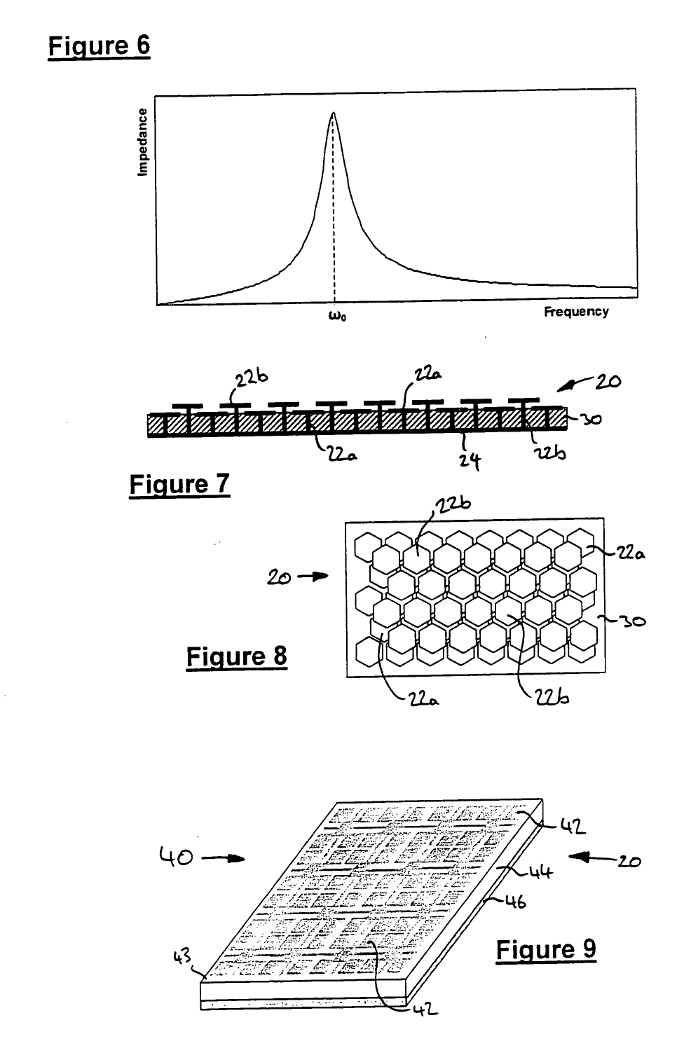

FIG. 6 is a graph of frequency against impedance of the periodic electromagnetic structure of FIG. 3;

FIG. 7 corresponds to the cross-sectional view of FIG. 5, but for a periodic electromagnetic structure according to a second embodiment of the invention;

FIG. 8 is a perspective view of the periodic electromagnetic structure of FIG. 7;

FIG. 9 is a perspective view of a periodic electromagnetic structure according to a third embodiment of the invention;

FIG. 10 is a perspective view of a periodic electromagnetic structure according to a fourth embodiment of the invention;

FIG. 11 is a plan view of the periodic electromagnetic structure of FIG. 10;

FIG. 12 is a perspective view of a periodic electromagnetic structure according to a fifth embodiment of the invention; and

FIG. 13 is a cross-section taken through line XII-XII of FIG. 12.

FIGS. 3 to 5 show a periodic electromagnetic structure 20 according to a first embodiment of the invention. The structure shown is a high-impedance surface akin to that disclosed in the Sievenpiper paper. Accordingly, the periodic electromagnetic structure 20 of FIGS. 3 to 5 finds application as a reflector that can be placed directly behind a microwave transmitter antenna.

The periodic electromagnetic structure 20 comprises a two-dimensional array of metal thumbtack-shaped protrusions 22 that extend from a flat metal sheet 24. The volume between the upper surface 26 and the lower surface 28 of the periodic electromagnetic structure 20 contains a dielectric 30 whose electromagnetic properties depend on the frequency of incident radiation. The inclusion of the frequency-dependent dielectric 30 means that the high-impedance surface provided by the periodic electromagnetic structure 20 results in a wider operational bandwidth than that of the prior art.

The periodic electromagnetic structure 20 of FIGS. 3 to 5 produces an array of capacitive and inductive elements 22: the origin of the capacitance and inductance is as already explained with reference to FIG. 2 (in fact, FIG. 2 need only be modified by the inclusion of the dielectric 30 to be apt for the present embodiment). The capacitive coupling is due to charge accumulation around the edges of neighbouring thumbtacks 22 and is proportional to the permittivity of the intervening dielectric 30. The inductive coupling is due to current loops that flow between neighbouring thumbtacks 22 driven by accumulated charges of opposite polarity and is proportional to the permeability of the dielectric 30 within the current loops.

The thumbtacks 22 at a particular position form a resonant LC circuit that can be though of as a capacitance and inductance placed in parallel. Taken together, the array of parallel resonant LC elements 22 form a periodic electromagnetic structure 20 that behaves as an RF filter. The impedance of a parallel resonant LC circuit, and the effective surface impedance of the periodic electromagnetic structure 20 is

$${Z}_{LC} = \frac{j ω L}{1 - {ω}^{2} LC} \qquad Equation 1$$

where ω is the frequency of the incident radiation and j is the square root of −1. The impedance of the periodic electromagnetic structure 20 varies with the wavelength of the incident radiation and has a maximum value at the resonant frequency of the LC circuit, as shown in FIG. 6. The resonant frequency ω₀ is given by

$${ω}_{0} = \frac{1}{\sqrt{LC}} \qquad Equation 2$$

The surface impedance is significantly higher than that of free space (377Ω) at the resonant frequency and falls on either side of the resonance through the impedance of free space to much lower values. The useful property of high reflectivity that this periodic electromagnetic structure 20 provides occurs for incident radiation with a frequency at, or around, the resonant frequency of the LC circuit. As mentioned before, the periodic electromagnetic structure 20 has in-phase image currents such that it reflects incident radiation with a zero phase change in the electric field (whereas a good electrical conductor reflects signals with a phase change of π causing loss of signal through destructive interference if the reflector is closer than a quarter wavelength from the transmitter antenna).

The useful operating bandwidth of this periodic electromagnetic structure 20, or any other periodic electromagnetic structure, can be defined as the width of the region with an impedance greater than that of free space, i.e.

$$BW = \frac{\sqrt{L / C}}{377} \qquad Equation 3$$

In the prior art, the values of L and C (i.e. the inductance and capacitance of the thumbtacks 22) is fixed and so the useful bandwidth is fixed over a relatively narrow range according to Equation 3 above.

However, we have appreciated that the inclusion of a dielectric 30 will modify L and C by virtue of their permeability and permittivity and, furthermore, that dielectrics exist whose permeability and/or permittivity are dependent upon the frequency of any incident radiation. The value of the inductance L(ω) is proportional to the permeability of the dielectric 30 within the inductive loop:
L(ω)∝ μ Equation 4
Similarly, value of the capacitance C(ω) is proportional to the permittivity of the dielectric across adjacent thumbtacks 22:
C(ω)∝ ε Equation 5

The resonant frequency coo of the LC elements 22 in the periodic electromagnetic structure 20 is given by

$${ω}_{0} ∝ \frac{1}{\sqrt{μ ɛ}} \qquad Equation 6$$

A dielectric 30 is chosen whose permeability and permittivity is a function of the frequency of the incident radiation ωᵢ according to the following form:

$$μ ɛ ∝ \frac{1}{{ω}_{i}^{2}} \qquad Equation 7$$

Substitution of Equation 6 into Equation 5 gives

$${ω}_{0} ∝ \frac{1}{\sqrt{\frac{1}{{ω}_{i}^{2}}}}$$

which simplifies to give ω₀∝ωᵢ, i.e. the resonant frequency of the periodic electromagnetic structure 20 is proportional to the frequency of any incident radiation and hence tracks the frequency of the radiation. Consequently the periodic electromagnetic structure 20 displays a resonant response over the range of frequencies for which Equation 7 holds. Consequently the range of frequencies over which this periodic electromagnetic structure 20 can operate is determined by the dielectric material properties. The absolute values of the operating frequency for a periodic electromagnetic structure 20 depends on the absolute values of L and C that, in turn, depend on the physical size and geometrical arrangement of the periodic electromagnetic structure 20. In principle the required response for the periodic electromagnetic structure 20 can be achieved in any frequency band over which a dielectric 30 is available with the characteristic of Equation 7.

Several responses are possible for the dielectric 30: the permittivity may remain constant such that Equation 7 simplifies to

$$μ ∝ \frac{1}{{ω}_{i}^{2}} ; \qquad Equation 8$$

the permeability may remain constant such that Equation 7 simplifies to

$$ɛ ∝ \frac{1}{{ω}_{i}^{2}} ; \qquad Equation 9$$

or both the permeability and the permittivity vary according to Equation 7. In this embodiment, the dielectric 30 used was a ferrite material type 4E1, obtainable from Philips Electronics UK Ltd of 420-430 London Road, Croydon, Surrey CR9 3QR, UK. This material has a permeability that varies with the frequency of the incident radiation according to the equation ω₀∝1/√μ over a frequency range of 300 MHz to 2 GHz.

The bandwidth of the periodic electromagnetic structure 20 is defined by Equation 3, and corresponds to the region where the impedance of the surface exceeds that of free space. Consequently, for a particular incident radiation frequency ωᵢ, there is a range of frequencies around the resonant frequency ω₀ for which the impedance of the surface exceeds that of free space. Consequently, there can be some variation from the form of Equation 7 that still results in a surface impedance greater than that of free space. This relaxes the requirement on the frequency dependence of the dielectric 30. Typical parameters could thus be as follows for a surface that is designed to operate from 200 MHz to 1 GHz.

The dielectric 30 is assumed to have a relative permeability of 1 at a frequency of 1 GHz and a permittivity that is constant over the operating range of 200 MHz to 1 GHz. The periodic electromagnetic structure 20 is designed such that the thumbtacks 22 have an inductance L₀ of 6 nH and a capacitance C₀ of 4.21 pF at a resonant frequency of 1 GHz. The operating bandwidth of the periodic electromagnetic structure 20 at the resonant frequency is 10%, as given by Equation 3.

As the dielectric 30 has the permeability-frequency response of Equation 8, then the inductance will be 24 nH at a frequency of 500 MHz. Equation 3 gives an operational bandwidth at this frequency of 20%. As the operating frequency is reduced, the bandwidth of the periodic electromagnetic structure 20 increases. At a frequency of 200 MHz the bandwidth of the structure is 50%.

Use of Equations 2 and 3 allows a calculation of the variation in inductance that is allowed for the surface impedance of the periodic electromagnetic structure 20 to remain above 377ω (i.e. the region in which the structure is regarded as a high-impedance surface). At a frequency of 1 GHz, the inductance and the relative permeability may both vary by ±10%. At a frequency of 200 MHz, the corresponding figure is ±50%. Consequently, if the periodic electromagnetic structure 20 is permitted to operate within the defined 10 operational bandwidth, a considerable degree of variation from Equation 6 is possible. Accordingly, the permeability and permittivity may be able merely to track changes in incident radiation frequency rather than having to adhere rigidly to the form dictated by Equation 7.

A second embodiment of the present invention is shown in FIGS. 7 and 8. This embodiment broadly corresponds to that of FIGS. 3 to 5 and so corresponding reference numerals are used for corresponding parts. Similarly, corresponding parts are not described in detail in order to avoid repetition. As is clear from FIGS. 7 and 8, the thumbtacks 22 are no longer of a common height but now form a two tier structure with short thumbtacks 22a and tall thumbtacks 22b. This arrangement increases capacitive coupling between thumbtacks 22a,b, as each thumbtack 22a,b may couple with its neighbours from the same tier and also neighbours from the other tier.

A third embodiment of the invention is shown in FIG. 9. In common with the previous two embodiments, the third embodiment is a high-impedance surface, but this time in the form of a UC-PBG 40. The UC-PBG 40 comprises a periodic metallic pattern 42, as shown in FIG. 9, that is printed onto a surface 43 of a dielectric substrate 44 that has a metallic ground plane 46 on its reverse side. The dielectric substrate 44 is made from ferrite material type 4E1, and so has a permeability that varies with the frequency of incident radiation according to Equation 8. Hence, the UC-PBG 40 has a resonant frequency that tracks the frequency of incident radiation and therefore reflects strongly radiation over a wide operational bandwidth.

FIGS. 10 and 11 show a fourth embodiment of the present invention. This embodiment corresponds to a split-ring resonator 50 with improved operational bandwidth. A number of metallic split-ring structures 52 are written onto a surface 53 of a dielectric substrate 54. One possible pattern is shown in FIGS. 10 and 11. The dielectric substrate 54 is made from ferrite material type 4E1.

FIGS. 12 and 13 show a fourth embodiment of the present invention, comprising a sandwich structure 60. Top 62 and bottom 64 silicon layers sandwich a middle layer 66 that comprises helical elements 68 set in a dielectric 70. The helical elements 68 are made from any suitable conducting metal such as copper and the dielectric 70 is made from ferrite material type 4E1. As the helical elements 68 are set within the dielectric 70, their LC characteristics are modified by the permittivity and permeability of the dielectric 70. The permeability of the dielectric 70 changes with the frequency of the incident radiation, and hence so does the resonant frequency of the sandwich structure 60. Accordingly, the periodic electromagnetic structure 20 has an improved operational bandwidth because the resonant frequency of the helical elements 68 tracks the frequency of the incident radiation.

The person skilled in the art will appreciate that modifications can be made to the embodiments described herein above without departing from the scope of the invention.

For example, FIGS. 12 and 13 show all the helical elements 68 to be aligned when set in the dielectric 70 However, the helical elements 68 may adopt a number of orientations, either such that they follow some order or such that they are randomly distributed between orientations. In addition, whilst the helical elements 68 are metallic in the above embodiment, they may be made from a dielectric material, a ceramic or a plastic.

In each of the embodiments described above, the dielectric 30;44;54;70 has been comprised of a single material, namely Philips ferrite material type 4E1. This material is suitable because it exhibits a permeability response that follows Equation 7. However, it is possible to derive a suitable frequency-permeability and/or frequency-permittivity characteristic by using a mixture of different materials. This approach may prove more successful in increasing the operational bandwidth of the periodic electromagnetic structure 20. One approach for adjusting the absolute frequency of operation is to use a material consisting of a suspension of magnetic particles in a dielectric binder. In this arrangement, the effective permeability of the composite material is reduced by the volume fraction of active magnetic material in the dielectric.

Alternatively, it is possible to produce a frequency-dependent permittivity and/or permeability by the use of artificial magnetic/dielectric materials. Such materials commonly consist of arrays of small conductive structures that exhibit an effective value of permeability/permittivity. See, for example, Brewitt-Taylor et al in IEEE Trans. Aut. Propn. 47, 4, 1999 or Ziolkowski and Auzanneau in Journal of Applied Physics, 82, 1997, pp 3195-3198.

The application for periodic electromagnetic structures 20 that has been emphasised above is in their use as reflectors. For this application, the periodic electromagnetic structures 20 are designed to have as high a surface impedance as is obtainable at resonance as this gives the greatest reflecting efficiency (this is because energy loss from the incident radiation through generation of surface currents is minimised). However, a second particularly useful application is in the use of periodic electromagnetic structures 20 for radar absorbing materials. As mentioned above, periodic electromagnetic structures 20 are generally designed to have a surface impedance at resonance greater than that of free space (377Ω). However, if the periodic electromagnetic structure 20 is designed to have an impedance of 377Ω at resonance, it is then matched to free space and thus becomes an important component of an absorber for any incident radiation. Moreover, incorporating a frequency-dependent dielectric 30;44;54;70 such that the resonant frequency of the periodic electromagnetic structure 20 follows the frequency of the incident radiation allows the design of low reflectivity structures that can operate over wide bandwidths.

1.-15. (canceled)

16. A periodic electromagnetic structure comprising an array of conducting LC elements in combination with a frequency-dependent dielectric whose permittivity and/or permeability varies according to the frequency of radiation incident thereon such that the resonant frequency of the LC elements follows the frequency of the incident radiation.

17. The structure of claim 16, wherein the frequency-dependent dielectric has a response to incident radiation such that the product of the permittivity and permeability of the dielectric varies in proportion to the reciprocal of the square of the frequency of the incident radiation.

18. The structure of claim 16, wherein the frequency-dependent dielectric has a response to incident radiation such that the permittivity of the dielectric generally varies in proportion to the reciprocal of the square of the frequency of the incident radiation and the permeability of the dielectric is substantially constant.

19. The structure of claim 16, wherein the frequency-dependent dielectric has a response to incident radiation such that the permeability of the dielectric generally varies in proportion to the reciprocal of the square of the frequency of the incident radiation and the permittivity of the dielectric is substantially constant.

20. The structure of claim 19, wherein the frequency-dependent dielectric is ferrite material type 4EI.

21. The structure of claim 16, rein the LC elements are protrusions from a flat conducting plate.

22. The structure of claim 21, wherein the frequency-dependent dielectric abuts the conducting plate the protrusions extend at least partially into the dielectric.

23. The structure of claim 22, wherein the protrusions are generally thumb tack shaped.

24. The structure of claim 19, wherein the structure forms an ultra compact photonic bandgap device.

25. The structure of claim 19, wherein the structure forms a split ring resonator.

26. The structure of claim 23, wherein the LC elements are disposed across the surface of the frequency-dependent dielectric.

27. The structure of claim 19, wherein the structure comprises chiral conductors).

28. The structure of claim 27, wherein the chiral conductors are helical.

29. The structure of claim 27, wherein the chiral conductors are set within the frequency dependent dielectric.

30. The structure of claim 16, wherein the structure forms a high-impedance surface.

31. The structure of claim 30, wherein the surface impedance of the periodic electromagnetic structure is substantially 377Ω.

32. An antenna comprising a periodic electromagnetic structure according to claim 16.

33. A mobile phone handset comprising an antenna according to claim 32.

34. A radar absorbent material comprising a periodic electromagnetic structure according to claim 16, wherein the impedance of the structure is substantially 377Ω, thereby to match the impedance of free space.
